(19) United States
(12) Patent Application Publication
(10) Pub. No.: US 2024/0376758 A1
(43) Pub. Date: Nov. 14, 2024

(54) WINDING DEVICE AND METHODS

(71) Applicant: Zhide David FENG, Northville, MI (US)

(72) Inventor: Zhide David FENG, Northville, MI (US)

(21) Appl. No.: 18/196,768

(22) Filed: May 12, 2023

(51) Int. Cl. E05D 13/00

(52) U.S. Cl. CPC E05D 13/1261; E05Y 2201/499; E05Y 2900/106

(57) ABSTRACT

A winding device for adjusting the elastic energy of an overhead door spring system installed on a wall structure, the door having at least a door panel which can be moved up and down constrained within a track. The door also has a counterbalance system with a coil spring having a stationary end and a winding end. The door system also has a central shaft held within the counterbalance system. The winding device has a worm gear with a flange, or collar portion, a worm screw engaged by the worm gear, a box or container or a retainer to hold the worm gear and worm screw together in an engagement status. The worm gear is engaged with the central shaft by at least one fastener. It can also be used to lift said door directly when said spring is broken, or there is no spring at all.

### FIELD OF THE INVENTION

The present invention relates to the adjustment of the elastic energy of a spring system for counterbalancing a sectional garage door, or overhead door. It also relates to lifting said door directly when said spring is broken, or there is no spring at all.

### BACKGROUND OF THE INVENTION

Traditionally, torsion springs used in combination with a garage door include a coil portion and a central axis, about which the coil portion is wound. A central shaft is disposed along the central axis of the torsion spring, with the spring being wound around the shaft. One end of the spring is fixed with a stationary cone, which is secured by a plate to an anchoring point, such as a wall structure. The other end of the spring fixed with a winding cone, which is wound until there is sufficient torque, and subsequently secured to the central shaft. Each end of the central shaft is pivotally supported by a support bracket, or an angle plate secured to the wall structure.

On a garage door, a torsion spring stores energy when wound, with that energy being transferred to cables attached to the spring and to the bottom of a garage door, such that the cables can balance the weight of the garage door in opening and closing. If a torsion spring breaks, a garage door will likely not function correctly, either by becoming incapacitated, or by opening asymmetrically and being off-track.

The installation or replacement of a torsion spring can be a dangerous and inefficient task. To remove the spring for maintenance or replacement, the spring must be unwound to release energy from the coils. Similarly, to install the spring, the spring must be wound to transfer, or store energy to the coils. Currently, often the tools used in this task are a pair of rods or bars. Regardless of whether the springs are being wound or unwound, the high amount of energy stored within the springs leads to danger for amateurs and professionals alike, in that a slight misstep can lead to the spring unwinding, similar to a propeller, launching the rods or bars away from the central shaft. Such a misstep can lead to cosmetic damage to items and structures surrounding the torsion springs, as well as serious physical damage or death to the person attempting to remove or install the springs. Moreover, since the springs require a large amount of torque, removing or installing torsion springs is physically taxing, representing danger to an installer's muscles and limbs due to the repetitive motion associated with each turn required to wind or unwind the springs.

Attempts have been made which are shown by prior arts to provide a tool that can help in the removal and installation of torsion springs by reducing the physical taxation incurred by an operator working on the torsion springs.

US2020/0290188 shows a prior art which allows an operator to use an electric drill of driver to turn a worm screw and then drive an engaged worm gear which is temporally attached to the spring. The worm gear has two split sections which are put together to surround the shaft and fixed with a winding cone which has been fixed the winding end of the spring already. Since it has two split worm gear sections, it is still too complicated for manufacturing and assembling.

US2014/0265082 shows another prior art which has a one-piece worm gear, and it can wind the central shaft for winding all springs attached to the shaft. But it has a worm screw having two separable parts: an adjustment shaft and an intermeshed worm with internal teeth for engaging with said adjustment shaft. The manufacturing for this prior art is still too complicated, and most important, it is not detachable, and it can not lift the door directly without the help of springs.

Accordingly, what is needed is a spring removable winding device that safely, easily, efficiently and less costly winds and unwinds a torsion spring with reduced injury risk for an operator. More specifically, if a winding device utilizes an integral worm gear and integral worm screw to replace either two split worm gear sections or split worm screw sections mentioned above, and if it can further function to turn all springs fixed with the shaft simultaneously, and is detachable or removable after winding operation, it will meet the objectives or has the advantages mentioned above.

If this winding device can lift the door directly by winding the shaft even without help of the spring, it may have extra advantage.

### SUMMARY OF THE INVENTION

A winding device for adjusting the elastic energy of an overhead door spring system installed on a wall structure, the door having at least a door panel which can be moved up and down constrained within a track. The door also has a counterbalance system with a coil spring having a stationary end and a winding end. The door system also has a central shaft held within the counterbalance system. The winding device has a worm gear with a flange, or collar portion, a worm screw engaged by the worm gear, a box or container or a retainer to hold the worm gear and worm screw together in an engagement status. The worm gear is engaged with the central shaft by at least one fastener.

It can also be used to lift said door directly when said spring is broken, or there is no spring at all.

### BRIEF DESCRIPTION OF THE DRAWINGS

FIG. 1 shows isometric view of the preferred embodiment of the present invention, an winding device is installed with a door system with a live shaft;

FIG. 2 shows isometric view of the bottom corner of the bottom panel and shows how the cable and roller are fitted with the bottom bracket;

FIG. 3 shows how the spring is installed with the central shaft and with the bracket (wall structure);

FIG. 4 shows the details about how the present invention is installed with the rod;

FIG. 5 shows the general isometric view of the preferred embodiment of the present invention;

FIG. 6 shows the inside structures of the preferred embodiment;

FIG. 7 shows the main body of the box, or retainer;

FIGS. 8 and 9 show the situation when the preferred embodiment of the present invention is installed with a door system with a dead shaft;

FIG. 10 through 12 show the situation when the preferred embodiment of the present invention is installed with a door system with a hollow live shaft;

FIG. 13 shows the third embodiment of the present invention;

FIG. 14 through 16 and 22 show the fourth embodiment of the present invention;

FIGS. 17 and 18 show the fifth embodiment of the present invention;

FIGS. 19 and 20 show the sixth embodiment of the present invention.

FIG. 21 shows a variation from the preferred embodiment, which uses a spur gear as a worm gear, and the center line of the worm screw is tilted with a small angle compared with that in the preferred embodiment.

FIG. 22 shows how the cross key works together with other parts;

FIG. 23 shows the exploded view of status one of the fourth embodiment which can accommodate two shafts with different diameters;

FIG. 24 shows the plain view of status one of the fourth embodiment;

FIG. 25 and FIG. 26 show the general isometric view of the second method of application of this winding device for lifting the door directly;

FIG. 27 shows the general isometric view of the third method of application of this winding device for lifting water bucket from the bottom of a water well;

FIG. 28 shows a local view of FIG. 27.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

Although the instant invention has been described in relation to particular embodiments thereof, many other variations and modifications and other uses will become apparent to those skilled in the art.

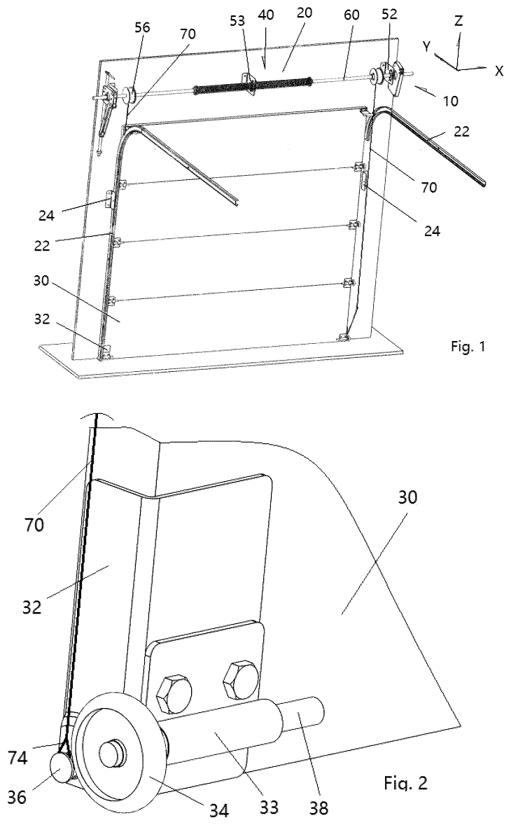

For interpretation of current invention, a global Cartesian coordinate system X-Y-Z is established as shown at FIG. 1.

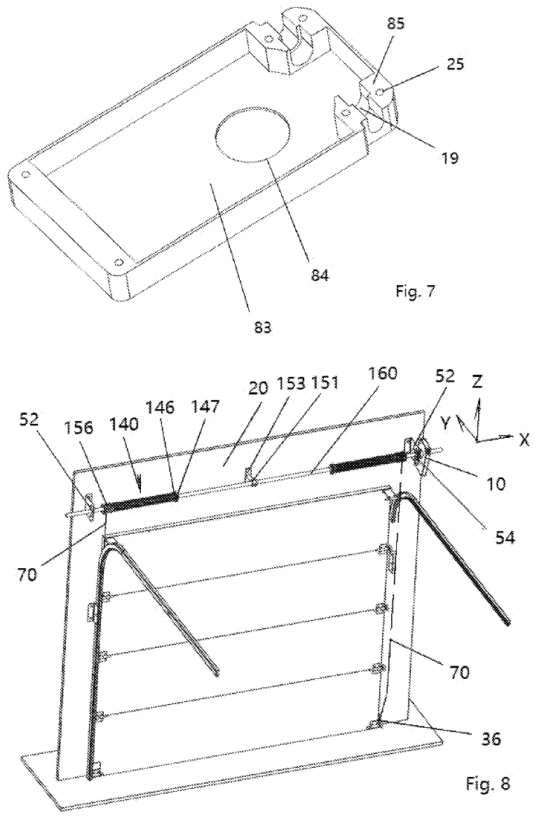

Referring to FIGS. 1-7, the vertical portion of both roller tracks 22 are mounted to a wall structure 20 through a bracket 24 (a vertical portion of the track on the right is hidden for better illustration of the cable). Said roller track usually has a U-shaped section cut. A bottom panel of door 30 has an angle plate 32 (FIG. 2) with a cable pin 36 on the panel's side face. A roller 34 with a short shaft 38 is mounted on a front face of door 30 at its bottom location through a bracket 33.

This bottom panel and other panels of the door which are connected with each other by hinges can be moved up and down through the rollers moving along the roller track 22, and is guided to turn about 90 degrees then is moved in —Y direction through the horizontal portion of roller track 22.

On the wall structure 20, a central shaft 60 is mounted oriented in X direction by brackets 52 and bearings 54 (FIG. 4) on both ends and through fasteners 55.

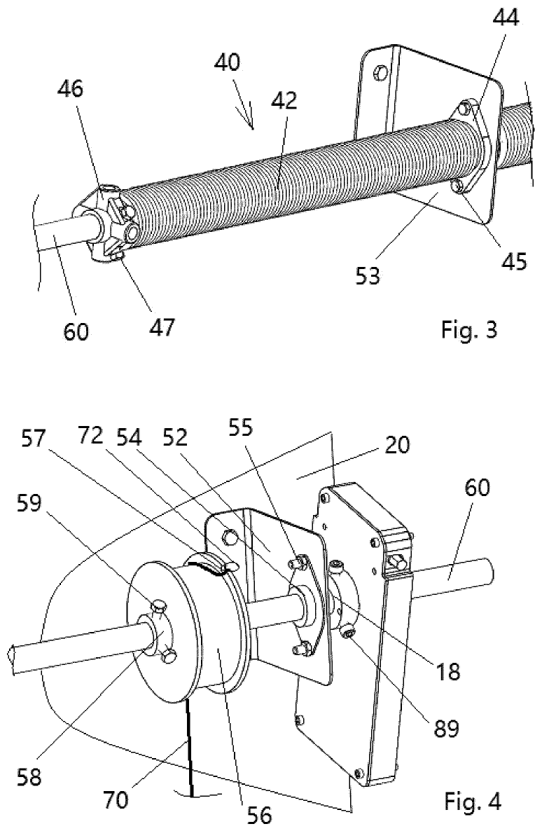

At least one spring unit 40 connects the wall structure 20 and the central shaft 60. The first end, or stationary end of spring unit 40 has the first end of spring body 42 fixed with stationary cone 44 which is fixed to wall structure 20 through bracket 53 and fasteners 45 (FIG. 3). The second end, or winding end of spring unit 40 has the second end of spring body 42 fixed with a winding cone 46, and said winding cone 46 is fixed with central shaft 60 through fastener, or set screw 47.

But before tightening set screw 47, the winding end of 40 is to be adjusted by being moved away along the shaft from its stationary end for some distance. This is called relax length, and it is because when the spring body 42 is wound usually in the direction that makes the spring diameter smaller and nominal length (from stationary end to winding end) longer. This distance is usually a little bit bigger than the amount equals to the product of rounds to be wound times the wire diameter of the spring.

If the present invention, the winding device 10 is applied to a door with single spring, or two or more identical springs having same orientation and all on one side (left or right) to the brackets they anchored to, and if without adjustment depicted at last paragraph, when the spring is wound, it will drive the central shaft in the direction from the stationary end of a spring to its winding end for the distance equals to the product of rounds to be wound times the wire diameter (assuming the spring is manufactured in the way that each adjacent coil has zero gap from each other, and there is no object blocks this movement).

As shown at FIG. 4, a drum 56 through its extension 58 is slidingly attached to central shaft 60 without tightening fasteners 59. Said drum 56 also has a notch 57 to hold the upper end fitting 72 of a cable 70, whose lower end fitting 74 is fixed with cable pin 36 at the lower end of panel of door 30.

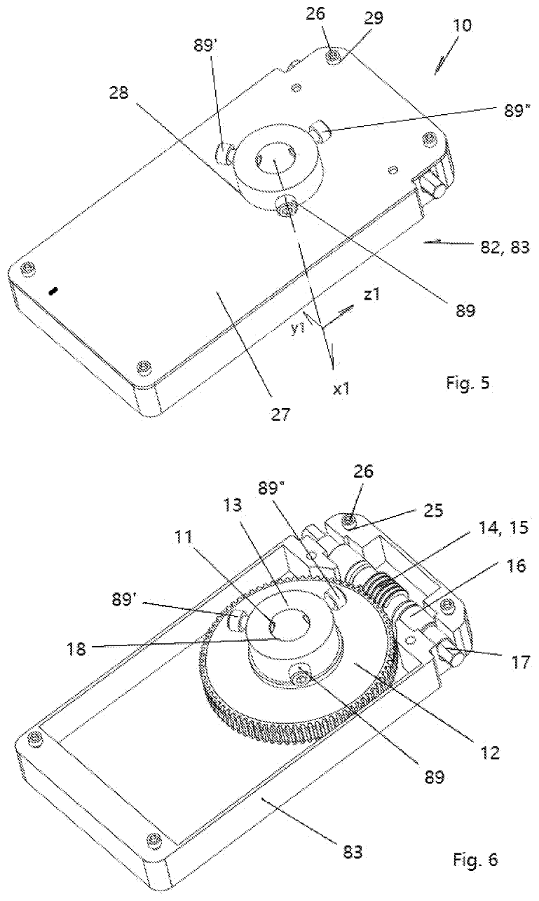

The present invention of a winding device 10 is shown at FIG. 5 through FIG. 7 with a local coordinate system x1-y1-z1 as shown at FIG. 5.

Said 10 winding device has a main box, or retainer 82 with a base body 83 having a first hole, or main aperture 84 having a center line collinear with x1, which would be also collinear with X direction when 10 winding device is installed with central shaft 60. Said base body 83 also has at least one, but usually two spacer portions 85 with second hole 19 whose center line parallel to y1 and usually perpendicular to center line of main aperture 84, and a plurality of third holes 25 parallel to x1. A worm gear 12 (FIG. 6) has an extension 13 in x1 direction and a central through hole 18 whose center line is in x1 direction. Said through hole passes through 12 including extension 13. Worm gear 12 also has teeth usually helical teeth in its periphery edge, and extension 13 has at least one thread hole 11 intersecting said hole 18.

Ideally said worm gear 12 has a structure with all teeth in its periphery edge made by one piece of material with no gap among teeth area. The worm gear with this structure is called an integral, or one-piece worm gear. If only said extension 13 is made separable from the main body of an one-piece worm gear, this worm gear is still regarded as a one-piece worm gear.

A worm screw 14 has spinal-shaped teeth 15, and an extension portion 16 usually on its each side. Extension portion 16 has a hex-shaped head, or boss 17 usually on its each end, but at least on one end.

Extension portion 16 pivotally engages with second hole 19.

A cover 27 holds worm gear 12 and worm screw 14 within the chamber formed by base body 83. Said cover 27 has a first hole 28 and a plurality of second holes 29 for matching third holes 25.

Worm screw 14 is restrained by base body 83, through both extension portion 16 being restrained by both second holes 19. The periphery face of extension 13 also pivotally engages with main aperture 84 of base body 83 on one end and engages first hole 28 of cover 27 on the other end. A plurality of fasteners 26 pass through second holes 29, third holes 25 for holding cover 27 and base body 83 together and keeping engagement between worm gear 12 and worm screw 14 within the chamber of base body 83.

As shown at FIG. 6, worm gear 12 and worm screw 14 are engaged with each other in the conventional engagement manner of a worm gear and a worm screw.

As shown at FIG. 1 and FIG. 4, for storing energy to the spring unit 40, said 10 winding device is engaged with central shaft 60, with hole 18 received by one end of central shaft 60, and at least one lock screw fastener 89 is tightened until its bottom end firmly presses said central shaft 60, then said 10 winding device is held together with central shaft 60 totally.

At this moment, the central shaft 60 has not mechanical communication with cable pin 36 yet, usually by keeping fastener 59 loose to let drum 56 free for rotation around central shaft 60, or by disconnecting either upper end fitting 72 of cable 70 from notch 57, or lower end fitting 74 of cable 70 from cable pin 36.

Then a driver, usually an automatic screw driver, or electric drill with an appropriate socket is used to engage said boss 17 then is driven usually in the direction leading to central shaft 60 to turn in −X direction (right hand rule). Since the stationary end of spring unit 40 is fixed with wall structure, and its winding end is fixed with central shaft 60, and one edge of said base body 83, usually its bottom edge close to the wall structure, is then propelled in +X direction to touch the wall structure, which provides grounding thereafter for turning 12 and central shaft 60 in −X direction. This turning will tighten all said springs fixed with the central shaft and store energy to all the springs in the counterbalance system simultaneously.

After storing energy to the spring, with confirmation that upper end fitting 72 of cable 70 is connected with notch 57, and lower end fitting 74 of cable 70 is connected with cable pin 36, then said drums 56 is turned a little bit in +X direction to overcome free play of cable 70 until it is reasonably tightened, then drum 56 is fixed fully with central shaft 60 by tightening fasteners 59.

At this moment, a full mechanical communication, or connection, has been built up between wall structure 20 and door 30 by their own even without said 10 winding device. The route of load for this connection between the door and the wall structure can be simplified as 30-36-74-70-72-57-56-60-40-53-20.

Now said 10 winding device can be removed from central shaft 60 after fastener 89 is loosen, and the door with assistant spring energy support is ready to work.

With this setting, when the door 30 is raised up, spring unit 40 will release energy to help raising the door. In the contrary, when door 30 is pushed down, the gravity of door 30 will help to store energy to spring unit 40.

If spring unit 40 needs to be dismantled from central shaft 60 for repairing or maintenance of an existing door system, said 10 winding device is installed with central shaft 60 as same as described above, then fasteners 59 are released, then said 17 is turned in the direction which turns central shaft 60 in +X direction until spring unit 40 is fully released to neutral, or free status. Then any the spring attached to the central shaft 60 is safe to be removed, or handled for other purposes.

The major difference between the present invention and prior arts such as US2020/0290188 is that this prior art turns the winding cone of the spring directly. Therefore its winding tool needs to be attached to a winding cone of the spring, which is at the mid-portion of the shaft between two supporting brackets (52) holding the shaft. This means that its worm gear needs to be split to at least two parts then be assembled around the central shaft to compose as a complete worm gear to hold the central shaft, and it also needs to be attached to the winding cone. In other words, this kind of winding apparatus has to be connected with both shaft and the spring before it is turn to wind the spring around the shaft. In comparison, the present invention 10 needs to be connected with the shaft only.

Another drawback of above prior art is that it can wind only one spring at a time.

The present invention 10 winding device winds the central shaft which winds all springs together attached to this shaft. Another advantage is that because it is received by an end of the shaft, and is attached with one end of the shaft (and the central shaft is fixed with the winding ends of all the spring), therefore it has an intact, or integral one-piece worm gear, leading to much easier and reliable installation and engagement. This one-piece structure saves manufacturing and installation costs and minimizes failure risks.

There are usually two kinds of counterbalance systems for overhead doors: dead axle and live axle.

Most counterbalance system for a garage door with a house in United States is that of live axle, which is illustrated in above paragraphs and FIG. 1 through FIG. 4. After full installation of this kind of system, when the door is being opened or closed, the axle, or the central shaft keeps rolling and serves as a torque transmittal link.

A significant percentage of overhead doors for trailer truck has a counterbalance system with a dead axle, or central shaft. This shaft just keeps static when the door is being opened or closed. There are usually two symmetrical springs. Each spring connects a winding cone on on its inboard end and a plug on the outboard end. The plug plays the same function as a drum described above for being connected with the first end of a cable.

Therefore, this dead shaft just keeps the springs usually oriented in cross car direction, but doesn't transmit torque between spring and the plugs. The plugs here are similar to the drums in above paragraphs. Once the door system is fully installed, the axle, or shaft keeps static with respect to the trailer.

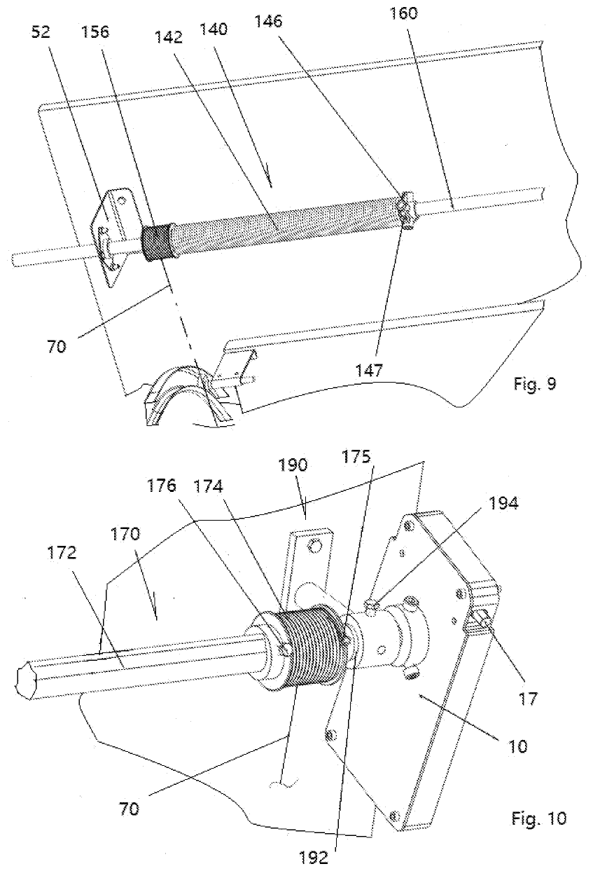

FIG. 8 and FIG. 9 show the configuration of a counterbalance system with a dead central shaft. In this case, a central bracket 153, which is fixed with wall structure 20, pivotally holds the shaft 160 at its middle portion.

A spring unit 140 has a main body 142, a plug 156, and a winding cone 146 having a lock screw 147, which fixes winding cone 146 and shaft 160 together. Plug 156 just engages shaft 160 pivotally and it is linked to cable pin 36 by cable 70.

This kind of system usually has two symmetrical spring units 140, one for holding the right end, and the other for the left end of the door.

For winding this counterbalance system, the present invention 10 winding device is engaged with one end of shaft 160 just the same as described above, then boss 17 is turned, which turns 12 and shaft 160, which turns winding cone 146 in +X direction. Since plug 156 is held by cable pin 36 through cable 70, turning of winding cone 146 with respect to plug 156 just tightens 140 and stores elastic energy to it.

After appropriate turns have been done, a lock screw 151 is tightened to fix shaft 160 fully together with central bracket 153 and wall structure 20, then 10 winding device is removed from shaft 160, and the counterbalance system is ready for operation in supporting up and down of the door.

Therefore, even though this shaft 160 is called a dead axle, or dead shaft, it means only that the shaft remains dead, or still once this counterbalance system is fully installed. But during the time of installation, shaft 160 is turned temperately as transmittal part to turn winding cones 146 and wind the springs 140.

A ratchet, or a one way clutch (not shown) can substitute for lock screw 151. The one-way clutch is fixed with central bracket 153. It allows shaft 160 to be turned in one way, or in +X direction in this case, but holds it when it tries to turn back in −X direction.

FIG. 10 shows the situation of a variation of counterbalance system with another live shaft, which is named external shaft for covering the springs within. This counterbalance system has a shaft plug assembly 170 having a hollow shaft 172 connecting one plug 174 by a fastener 176 at each end symmetrically. Said hollow shaft 172 has a non-circular section cut.

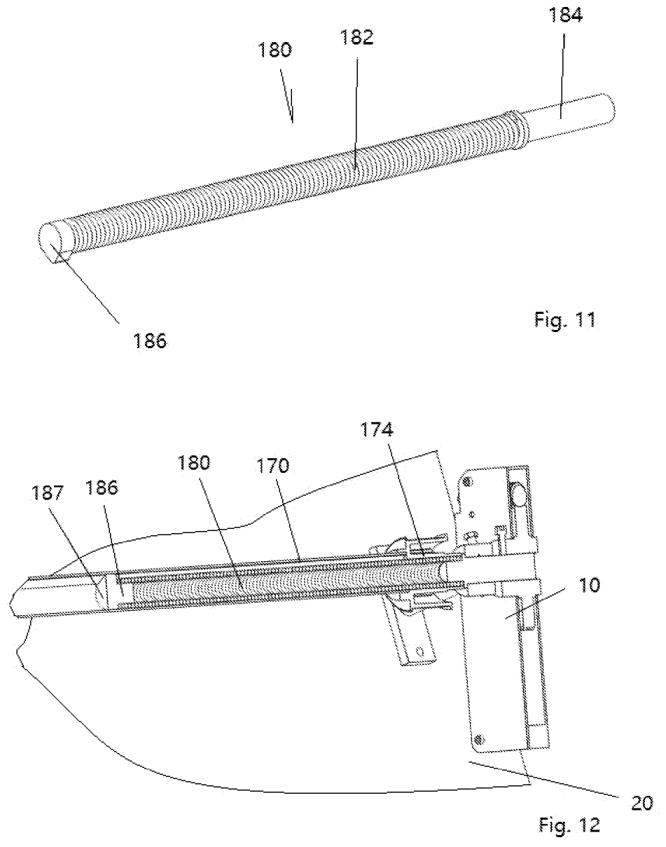

As shown at FIG. 11, a spring assembly 180 has a spring 182 with its inboard end being fixed with a fitting 186 having a portion with a section cut shape of non-circular 187, and its outboard end fixed with an adjustment head, or pin 184. With its nor-circular shape, fitting 186 cannot be turned around X direction with respect to hollow shaft 172, but can be slid in and out freely.

Each said spring assembly 180 is inserted into shaft plug assembly 170 from both left and right end with adjustment pin 184 staying outboard and protruding out from shaft plug assembly 170, the shank portion of 184 is held by a hole 192 of support bracket 190. The center line of said hole 192 is collinear to X.

Then the notch 175 on plug 174 is connected with cable pin 36 of the door 30 by cable 70 for building mechanical communication between 180 and door 30, then 10 winding device is fixed with adjustment pin 184 fully, then boss 17 is turned for winding spring assembly 180 in +X direction for storing energy, then fastener 194 fixes adjustment pin 184 with support bracket 190, then winding device 10 can be removed away. Then the spring of another side is wound in the same way, and the winding device 10 is removed away again.

FIG. 12 shows the section cut along X coordinate.

In normal operation of up and down of the door, adjustment pin 184 keeps still, while the whole shaft plug assembly 170 including the hollow shaft 172 and two plugs 174 are turned for raising or lowering down the door. Hollow shaft 172 in this application is not just a decorative part but a functional part serving as a shaft connecting two plugs together, and additionally also protects the springs within its hollow shape.

In summary, no matter what kind of style of counterbalance system, there is a connecting means fixed with one end of the spring, this connecting means can either be a through shaft, or just a short extension protruded out of the outboard end of said spring and out of the one end the external shaft. This short extension is named adjustment head, or pin above.

Generally speaking, for installing the winding device 10, the center through hole of the worm gear of the winding device 10 is received by and engaged with the connecting means of the spring of the counterbalance system of an overhead door system, and the box of the winding device 10 abuts the wall structure with which said door is installed, then the winding device is ready for adjustment of the elastic energy of the spring.

### Other Embodiments

As shown at FIG. 6, the second embodiment of the present invention 10 winding device can has three lock screw fasteners 89, 89′, 89″ distributed evenly in 360 degrees, or being 120 degrees apart from each other.

Since these screws are close to the wall structure 20 and the bracket 52, the screw being closest to wall structure 20 may not be accessible easily due to limited space available for turning that screw, but the other two are usually accessible.

Therefore, 10 winding device is connected with central shaft 60 in this way follows:

An accessible first one (fastener 89) is selected and tighten very slightly with a torque amount of T, but with feeling surely that the bottom of the screw touches the shaft, meaning that there is no obvious free play normally (in a direction perpendicular to X coordinate) between 12 and central shaft 60, but meantime 10 winding device can be removed out along X coordinate from central shaft 60 for full disengagement from central shaft 60; then the second one (fastener 89′), which is the most accessible of the other two, is tightened with a torque amount of T2 usually equaling to 2-100 times of T; then boss 17 is turned leading to turn 12 to an angle usually of 45-180 degrees, the original hardest accessible one, or the third one (fastener 89″) is accessible easily, is then tightened with a torque amount of T3 usually equaling to 2-100 times of T2. Then 12 and central shaft 60 together can be turned for winding the springs with an appropriate angles, but not necessary with integral rounds. Therefore, often the orientation of these three screws after winding are different from that before winding. Then, fastener 59 is tightened for connecting the door 30 and the spring unit 40 together by the cable 70.

After installation as described above, when 10 winding device is released from central shaft 60, usually at least two of these three screws are accessible easily. Then, with help of an appropriate wrench, the most easily accessible two screws are loosened, then 10 winding device can be removed along X coordinate from central shaft 60 easily by overcoming slight friction. The most easily accessible two screws mentioned above can be one of these three combinations: fastener 89 and 89′, or fastener 89 and 89″, or fastener 89′ and 89″.

With this method, the shaft and the spring can be wound in an arbitrary angle, with no difficulty for removing 10 winding device out from central shaft 60 after installation.

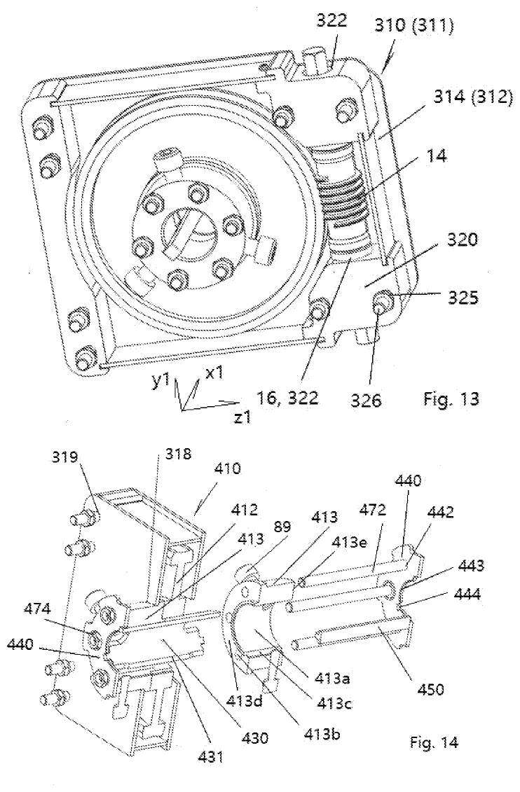

As shown at FIG. 13, the third embodiment of winding device 310 has a box, or retainer 311 for substitution of main box/retainer 82 of as discussed above. Said retainer 311 usually has an identical front plate 312 and back plate 314 (front plate 312 is hidden for illustration of other parts), with both having a first hole 318 similar to first hole 28 and a plurality of secondary holes 319 (FIG. 14), and two spacers 320 each has a first through hole 322 with center line parallel to y1 for receiving extension portion 16 of 14 on both ends, and at least one second through hole 325 with center line parallel to x1. At least one fastener 326 at each end holds front plate 312, spacer 320 and back plate 314 together. With this embodiment, the manufacturing is much more simplified compared with that of the embodiment described above. Said front plate 312 and back plate 314 can be made by stamping, or sharing, or trimming operation, while the spacer can be made by sharing, or extrusion operation. Above three parts can also be made by laser cut, or other equivalent operation too.

In above three embodiments, for keeping the center line of 14 parallel to y1, or perpendicular to x1, worm gear 12 is usually a helical gear.

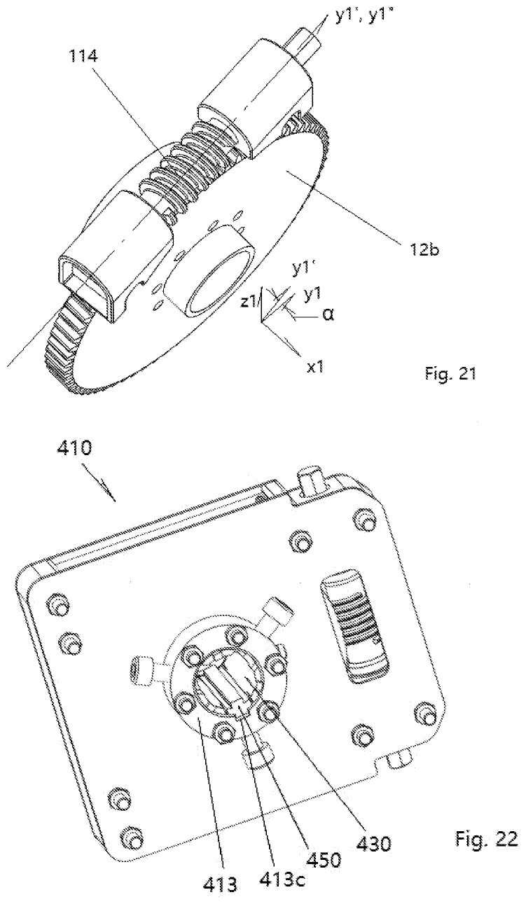

FIG. 21 shows a variation from the third embodiment, which uses a spur gear 12b as a worm gear. Spur gear 12b is a gear wheel with radical teeth parallel to its axis, or x1 in this case, which can save manufacturing cost compared with a helical gear. With this variation, the center line y1′of a worm screw 114 is not perpendicular to x1, or collinear to y1 anymore, but has a small angle a with y1. Accordingly, the center line y1″ of corresponding first hole 322b of spacer 320b needs to have an angle a with respect to y1 as well, which holds y1′ collinear with y1″.

This variation does not have a substantive impact on the essence of either this third embodiment, or the present invention as a whole.

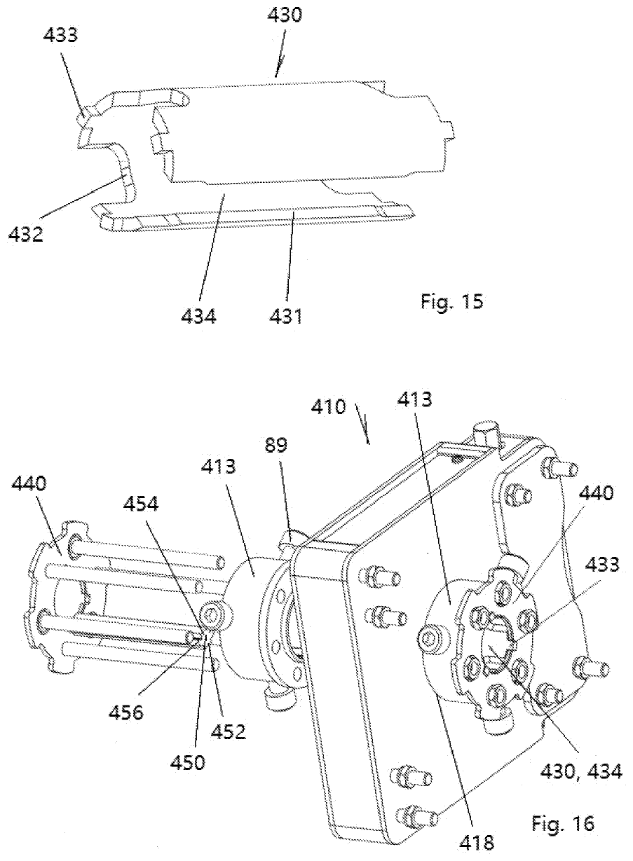

Now referring to FIGS. 14 and 15, the fourth embodiment of the winding device 410 can accommodate two shaft sizes, usually for that of status one with a diameter of one inch and status two of 1.25 inches.

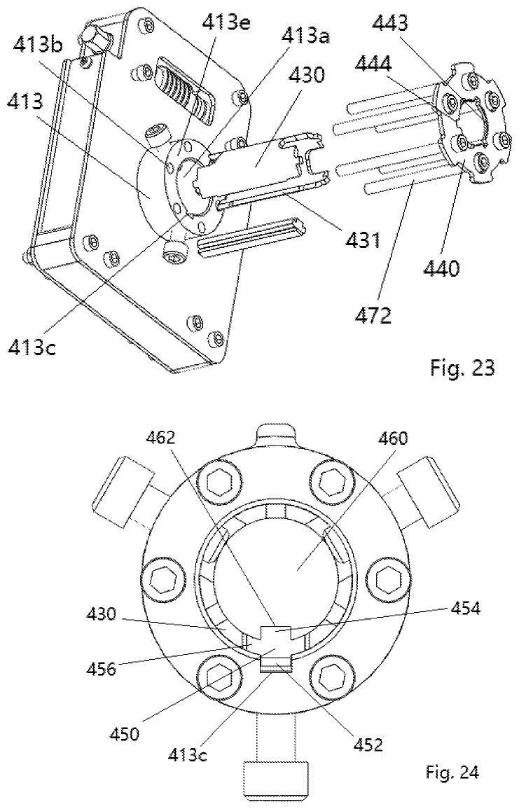

FIG. 14 is an exploded and section cut view and shows the status one for working together with a smaller shaft. While FIG. 23 is another exploded view of this status. This fourth embodiment has two collars 413 for sandwiching a worm gear 412. Said collar 413 has a center hole 413a, a plurality of lateral through holes 413b, and recession 413c which is formed in edge portion 413a. Within the center holes of worm gear 412 and collar 413, there is a sleeve 430 shown at FIG. 15 and FIG. 23. Said sleeve 430 has an opening gap 431, and a plurality of protrusion 433 at each circular edge, and there are plurality of C-shaped openings 432 at each circular edge too.

There are two ring plates 440 each having a center hole 443 which has a plurality of notches 444, and a plurality of holes 442.

Said sleeve 430 is inserted into 413a, then each ring plate 440 presses on outface 413e of collar 413, leading to that two ring plate 440 sandwich two collars 413 and one worm gear 412 together, then a bolt 472 passes hole 442, 413b, a hole 412b (FIG. 28) in worm gear 412, another 413b and another hole 442, then they are locked by a nut 474, with notch 444 being engaged with protrusion 433. With this setting, sleeve 430 can neither be moved out from the rest of winding device 410, nor be turned with respect to the rest of winding device 410.

As shown at FIGS. 22, FIG. 23 and FIG. 24, a cross key 450 has a cross shape in section cut. Said cross key 450 has an out protrusion 452, an in protrusion 454, and two side protrusions 456. Said out protrusion 452 is engaged with 413c, with both side protrusions 456 being covered by opening gap 431, and with in protrusion 454 entering within the circular contour of column-shaped aperture 434 of sleeve 430. Said in protrusion 454 is to be engaged with a key opening channel 462 (not shown) of a typical shaft 460 with C-shaped section cut for a heavy garage door. This shaft usually has a nominal diameter of one inch in US. FIG. 22 (ring plate 440 hidden), FIG. 23, and FIG. 24 show clearly how sleeve 430, cross key 450 and recession 413c work together.

Said c-shaped opening 432 yields, or opens a space for fastener 89 to engage with collar 413 first, then pass through sleeve 430 to press the shaft 460 for holding winding device 410 and the shaft 460 together as in the same way shown at above embodiments.

With the help of cross key 450, said winding device 410 can turn shaft 460 with a higher torque without slippage.

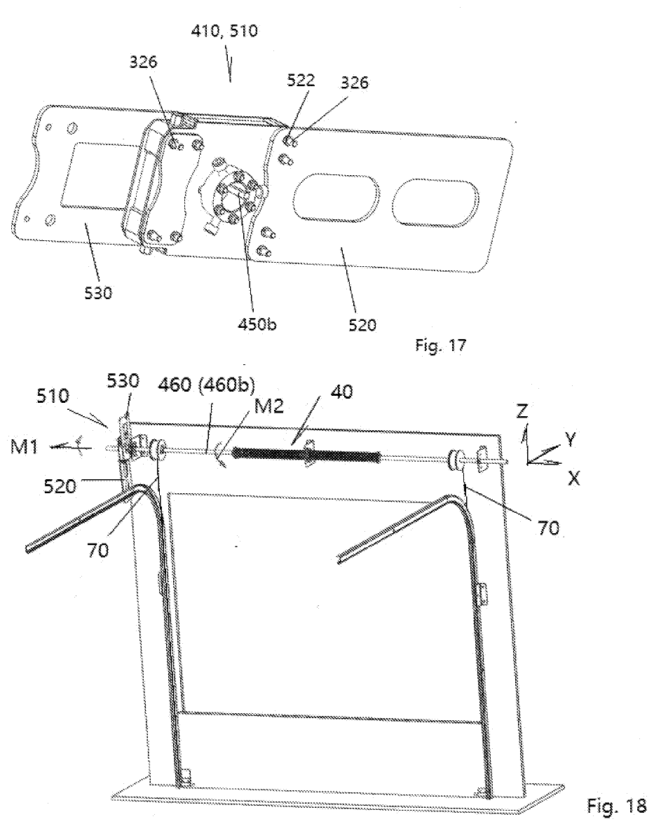

FIG. 17 shows the status two of winding device 410 when it is to be worked together with a bigger shaft 460b (not shown, but it has similar geometry as that of shaft 460, but with bigger diameter). For this application, ring plate 440, cross key 450, and sleeve 430 are all removed away, but a straight key 450b can be added for engaging 413c and an opening channel (not shown) of a bigger shaft 460b with C-shaped section cut (not shown) together. This bigger shaft usually has a nominal diameter of 1.25 inches in US.

The fifth embodiment of a winding device 510 also shown in FIG. 17 has a first extension plate 520 with usually at least two holes 522, and an second extension plate 530 with usually at least two holes 532 (not shown, but they are similar to hole 522). At least two holes 522 are received by at least two fasteners 326 which is at the bottom portion of the main body of winding device 510, and at least two holes 532 are received by at least two fasteners 326 at the top portion of main body of winding device 510.

When this embodiment is used for winding a shaft, said first extension plate 520 can provide a longer arm in providing a larger torque to turn the shaft 460.

FIG. 18 shows how winding device 510 is installed with shaft 460 for a live shaft application.

In the winding time for winding the springs, shaft 460 is turned in −X direction, and said winding device 510 provides supporting torque M1 to shaft 460 in −X direction to balance gradually stronger resistance torque M2 in spring unit 40 which tries to turn shaft 460 in +X direction. In normal situation of winding, M2 equals to −M1. If during the winding time, the counterbalance system suddenly fails, such as the spring unit 40 is broken leading to no M2 anymore, then winding device 510 and shaft 460 is driven by M1 to turn in −X direction. If without second extension plate 530, most probably the winding device including first extension plate 520 is suddenly turned in −X for more than 180 degree in a dangerous manner until an original bottom edge of first extension plate 520 touches wall structure 20 at a location above shaft 460. With the help of second extension plate 530, and when the counterbalance system fails suddenly, the top edge of second extension plate 530 will touch the wall structure quickly then stop turning of winding device 510 in a much smaller angle, such as within 30 degrees.

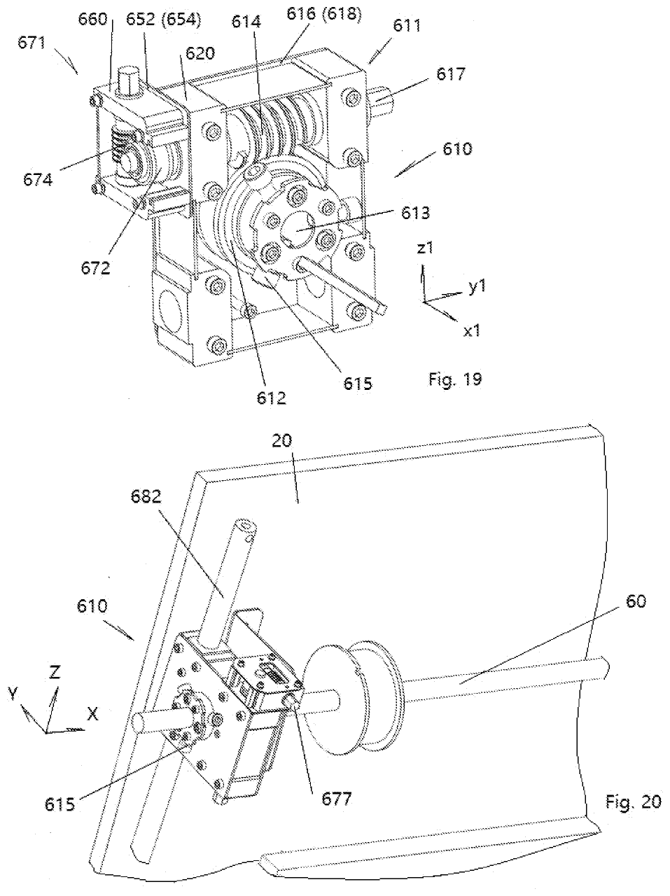

The sixth embodiment of a winding device 610 is shown at FIG. 19. Said winding device 610 is a dual-stage winding device having two sets of worm drive mechanisms working together. Similar to the previously embodiments, the primary stage has a first worm screw 614 engaged with first worm gear 612 both within a first box, or retainer 611 which is similar to retainer 311. Said retainer 611 has a back plate 616 and a front plate 618 (hidden for showing other parts, but is basically the same as back plate 616) sandwiching spacers 620 which is similar to spacer 320. A secondary back plate 652 is connected with one of the spacers 620. A secondary back plate 652 together with a secondary front plate 654 (hidden for showing other parts, but is basically the same as back plate 652) sandwich two secondary spacer 660 to form a secondary box, or retainer 671, A secondary worm gear 672 is formed on, or connected by one end of first worm screw 614, which renders the center line of secondary worm gear 672 collinear with that of first worm screw 614. Said secondary box, or retainer 671 keeps a secondary worm screw 674 engaged with secondary worm gear 672.

As shown by FIGS. 19 and 20, a door system with a live shaft has winding device 610 engaged with central shaft 60 by locking screw 615 with central shaft 60. Said winding device 610 also has an extension bar 682 with its bottom leaning on wall structure 20. Said extension bar 682 is oriented in y1 direction, and generally parallel to Z direction. The bottom of 682 is much lower than central shaft 60, and the top of 682 is obviously higher than central shaft 60. When the extension pin 677 of secondary worm screw 674 is turned in one direction, said central shaft 60 is turned in −X direction for storing energy to spring unit 40. Connection between a drum and the door by a cable is pretty much the same as that in the preferred embodiment. If in case the counterbalance system fails, the top end of extension bar 682 plays the same role as second extension plate 530 as in the last embodiment.

With this dual-stage setting, this winding device can provide a higher transmission ratio for lifting a heavier door.

The first method for application of the present invention has been illustrated in all above specification. This first method is for winding at least one spring received by the central shaft.

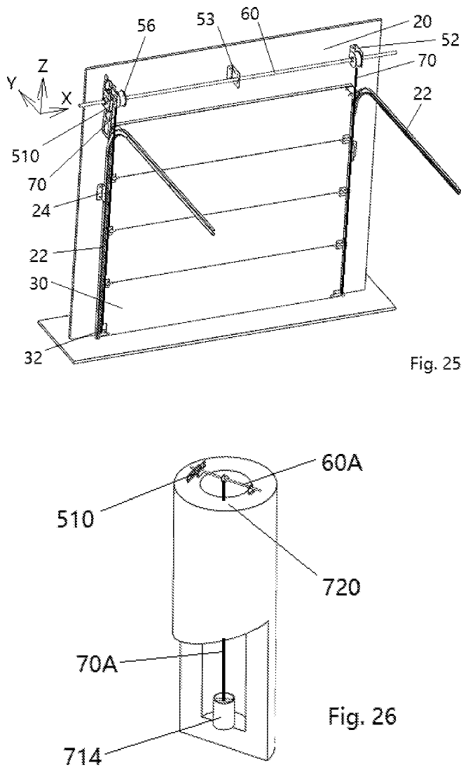

FIG. 25 shows the second method of using this invention for the situation that the counterbalance system doesn't work, such as that the springs are broken, or removed from the situation shown at FIG. 1. In this application, said winding device is not used to wind the spring, but used to lift, or raise the door directly, typically for handling emergency situation after the spring has been broken for lifting the door for a short period of time before the counterbalance system has been restored to fully operable.

Said 510 is engaged with central shaft 60, with its main hole 18 received by one end of 60 with said 520 facing downward, and at least one lock screw fastener 89 is tightened until its bottom end firmly presses said central shaft 60, then the collar of said 510 is engaged and fixed together with 60 totally.

Then each cable 70 is confirmed to be tightened, otherwise each fastener 59 is loosened first, then each drum 56 is turned in +X direction to overcome its free play, then said fastener 59 on each side is turned back to fix each drum 56 with shaft 60.

Then a driver, usually an automatic screw driver, or electric drill with an appropriate socket is used to engage said boss 17 to turn it usually in the direction leading to central shaft 60 to turn in +X direction (right hand rule).

This turning causes the cable 70 to raise the door 30 up, but at the same time said 30 also tries to pull said 70 downward leading said 60 to turn in −X direction until said 530's upper corner close to said 20 touches said 20, then said 60 keeps being turned in +X direction for raising said 30 to fully opened or partially opened location.

For closing, or lowering down the door, said electric drill is turned in opposite direction which turns said 60 in −X direction.

Said 510 can also be placed upside down to let said 520, rather than 530, provide stronger supporting torque for winding the shaft to lift the door.

The third method of applying this invention is for moving an object from location one to location two.

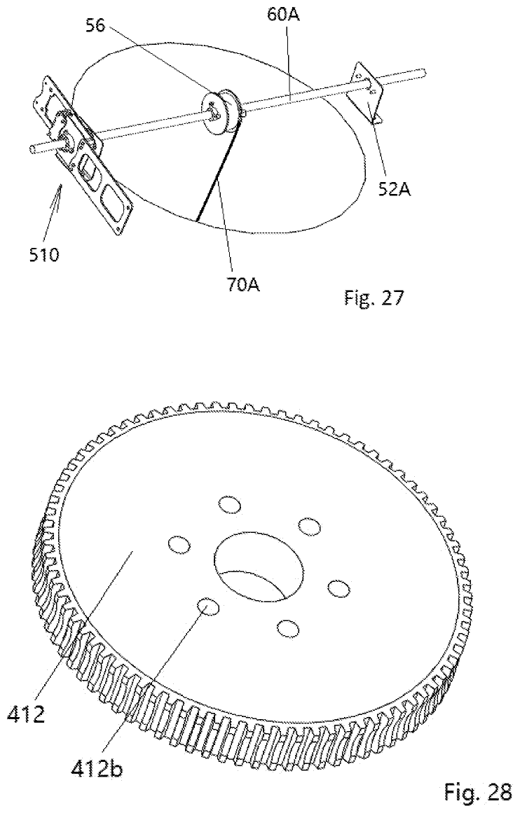

Referring to FIG. 26 and FIG. 27, There is a water well structure 720 having water within. A central shaft 60A is pivotally supported by two brackets 52A. A drum 56 is fixed with said shaft. A rope 70A connects a water bucket 714 and said 56 together.

Said winding device 10 is fixed with one end of 60A, and it is rested on the upper surface of 720.

When the worm screw of said 510 is turned, said 714 is raised up through 70A.

Generally speaking, said winding device can be mount with a general shaft which is pivotally retained to a general structure on location one. When said winding device is turned, a flexible element fixed with said shaft and a general object originally situated on location two can be pulled to be closer to location one. The pulling direction is arbitrary, which can be up and down, or horizontal oriented, or in any direction.

What is claimed is:

1. A winding device for adjusting the elastic energy of an counterbalance system of an overhead door system installed with a wall structure, said door system having at least a door panel which can be moved up and down with guidance of a track, said counterbalance system having a coil spring with a stationary end and a winding end, said stationary end being fixed with said wall structure directly or indirectly, said counterbalance system also having a central shaft to be held within said spring, said counterbalance system also having a cable whose upper end is connected with said winding end directly, or through said central shaft, and whose lower end is connected with said panel, said winding device comprising: a worm gear, said worm gear having a flange portion, said worm gear including said flange portion having a center through hole along its center line; a worm screw engaged by said worm gear; and a box, or container, or retainer to hold said worm gear and worm screw together in engagement status; wherein said center through hole of said worm gear being engaged with said central shaft, and being fixed fully together by a fastener group which has at least one fastener; and wherein said winding device being detachable from said shaft after working with said counterbalance system.

2. The winding device of claim 1, wherein said fastener group has three fasteners which are basically evenly distributed in 360 degrees.

3. A winding device for operation of an overhead door system having a connecting means, or shaft, said winding device comprising: a worm gear, said worm gear having at least one flange portion, said worm gear including said flange portion having a center through hole along its center line; a worm screw; a box, or retainer to keep said worm gear and worm screw together in engagement status; and a group of first fasteners having at least one fastener attached to said flange portion for fixing said flange portion to said connecting means.

4. A winding device for working together with a general shaft to move a general object from location one to location two, said winding device comprising: a worm gear, said worm gear having a center through hole along its center line; a worm screw; a box, or retainer to keep said worm gear and worm screw together in engagement status; and a group of first fasteners having at least one fastener attached to said worm gear for fixing it to said shaft.

5. A winding device of claim 3, wherein said worm gear is a one-piece worm gear.

6. A winding device of claim 5, wherein said worm screw is a one-piece worm screw.

7. A winding device of claim 3, wherein said group of first fasteners has three fasteners which are basically evenly distributed in 360 degrees.

8. The winding device of claim 3, wherein said box has a main body and a cover, and a group of second fasteners, said main body having three directions: a first direction, a second direction and a third direction, said three directions being generally perpendicular to each other, said worm screw and said worm gear being located and constrained in an opening of said main body, said main body having a basically circular first though hole whose center line defines said first direction, and having a second hole parallel to said second direction, and having at least one third through hole parallel to said first direction; said cover being basically a flat plate having three directions similar to those of said main body, wherein said cover has a thickness much thinner in said first direction, said cover having a first through hole corresponding to said first through hole of said main body, and having at least one second through hole corresponding to said third through hole of said main body; said flange portions of said worm gear being pivotally engaged with both first through holes of said main body and said cover; at least one end of said worm screw being pivotally engaged with said second hole of said main body; and said second fasteners passing through both said second through holes of said cover and said third through holes of said main body for binding them together, which hold said worm gear and said worm screw within.

9. The winding device of claim 3, wherein said box has a front plate and a back plate basically identical to said front plate, and two spacers for separating said front plate and back plate from each other, which provides space to hold said worm gear and said worm screw within.

10. The winding device of claim 9, wherein both said front plate and said back plate each has a first hole collinear to said first direction and at least two second holes parallel to said first direction; said spacers each having a first through holes parallel to said second direction, and each having at least one second through hole parallel to said first direction; said winding device also having a group of second fasteners for passing through both second holes of said front plate and said back plate, and said second through holes of said spacer between said front plate and said back plate for binding them together; said worm gear having two flange portions, with a first flange portion in a positive end and the second flange portion in a negative end, said first flange portion being pivotally engaged with said first hole of said front plate, and said second flange portion being pivotally engaged with said first hole of said back plate; and wherein one end of said worm screw being pivotally engaged with said first through holes of said spacer.

11. The winding device of claim 9, wherein said both front plate and back plate are made of sheet metal.

12. The winding device of claim 9, wherein said spacers are made by an extrusion procedure, or laser cut, or other equivalent means.

13. The winding device of claim 3, said winding device further comprise a sleeve adapted to be detachably inserted within said center through hole of said worm gear.

14. The winding device of claim 3, wherein said worm gear has two flange portions, with a first flange portion in a positive end and a second flange portion in a negative end; said winding device further comprising a detachable sleeve and a detachable pair of ring plates both together sandwiching said sleeve and said first flange portion and said second flange portion; said each ring plate being attached to each of said first and second flange portions by a third fastener.

15. The winding device of claim 3, said winding device further comprise a second worm gear, a second worm screw, and a second box, the center line of said second worm gear being collinear with the center line of said worm screw, said second box being attached to one of said spacers for holding said second worm gear and said second worm screw in engagement status.

16. The winding device of claim 3, said winding device further comprise a first extension plate fixed to said box, said first extension plate actually extending said winding device dimensioned in said third direction.

17. The winding device of claim 16, said winding device further comprise a second extension plate fixed to said box, said second extension plate actually extending said winding device dimensioned in also said third direction but opposite to said first extension plate.

18. The winding device of claim 3, wherein said counterbalance system has a plug assembly, each end of said plug assembly having a coil spring and a connecting means, said connecting means having an inboard end and an outboard end, said inboard end being connected with said spring and said outboard end being protruded out from an end of said plug assembly, said center through hole of said winding device being received by and engaged with said connecting means for adjusting elastic energy of said spring.

19. The winding device in claim 15, wherein said second worm gear is made on one end of said worm screw directly.

20. A winding device for lifting an overhead door system installed with a wall structure, said door system having at least a door panel which can be moved up and down with guidance of a track, said door system also having a central shaft being fixed on said wall structure and above said door panel, said door system also having a cable whose upper end is connected with said central shaft, and whose lower end is connected with said panel, said winding device comprising: a worm gear, said worm gear having a flange portion, said worm gear including said flange portion having a center through hole along its center line; a worm screw engaged by said worm gear; and a box, or container, or retainer to hold said worm gear and worm screw together in engagement status; wherein said center through hole of said worm gear being engaged with said central shaft, and being fixed with said central shaft; and wherein when said winding device being capable to turned said shaft to lift said door panel; wherein said winding device being detachable from said shaft after being used to lift said door panel.
